(19) United States
(12) Patent Application Publication
(10) Pub. No.: US 2018/0215004 A1
(43) Pub. Date: Aug. 2, 2018

(54) SYSTEM FOR SHARPENING CUTTING EDGES

(71) Applicant: The Sausage Maker, Inc., Buffalo, NY (US)

(72) Inventor: Alexander W. Cornwell, Elma, NY (US)

(73) Assignee: The Sausage Maker, Inc., Buffalo, NY (US)

(21) Appl. No.: 15/881,175

(22) Filed: Jan. 26, 2018

Related U.S. Application Data
(60) Provisional application No. 62/451,264, filed on Jan. 27, 2017.

(51) Int. Cl. B24B 3/36; B02C 18/06; B24B 45/00

(52) U.S. Cl. CPC B24B 3/366; B24B 45/003; B02C 18/062

(57) ABSTRACT

A sharpening system for a meat grinder is provided. The sharpening system embodies two types of sharpening stones for sharpening the cutting edges of the knife blade and the hole plate, respectively, of the meat grinder, wherein each type of sharpening stone operatively associates to the drive arbor of the meat grinder. By interchangeably replacing the knife blade along the drive arbor with one type of sharpening stone so as to sharpen and resurface the hole plate, or replacing the hole plate along the drive with the other type of sharpening stone to sharpen and resurface the knife blade, the present invention provides hands-free sharpening with no additional machines or tools.

### CROSS-REFERENCE TO RELATED APPLICATION

This application claims the benefit of priority of U.S. provisional application No. 62/245,264, filed 27 Jan. 2017, the contents of which are herein incorporated by reference.

### BACKGROUND OF THE INVENTION

The present invention relates to systems for sharpening cutting edges and, more particularly, to a system for sharpening the cutting edges of a meat grinder through interchangeably attaching sets of sharpening stones to the universal grinder drive unit of the meat grinder, thereby sharpening the cutting edges of both the cutting knife and the hole plate of the meat grinder.

There is not a safe and efficient way to sharpen the knives blades and cutting (hole) plates of meat grinders. Standard sharpening stones or sandpaper can be inefficient and uneven in their sharpening abilities. Sharpening using electric sanders can be dangerous as the parts being sharpened are very small, while sharpening pieces by hand can be time consuming and provide uneven results. Currently there is not a system that fits inside of meat grinders for sharpening the meat grinder's knife and hole plate cutting edges.

As can be seen, there is a need for an interchangeable system for attaching sets of sharpening stones to a universal grinder drive unit of a meat grinder for sharpening the knife and hole plate cutting edges of the meat grinder itself, thereby not requiring additional machines or tools.

The present invention includes a set of two stones designed to the corresponding size of the meat grinder is used to sharpen the knives/blades and cutting (hole) plates thereof: a first set of stones with a square arbor fitted inside the meat grinder, to the universal grinder drive unit, for removing material and resurfacing the cutting hole plate; and a second set of stones with a round arbor adapted to attach to the same universal grinder drive unit, for removing material and resurfacing/sharpening the cutting knife blades. The sharpening process can be powered electrically with electric grinder units, or powered manually by turning the handle of manual grinder units.

### SUMMARY OF THE INVENTION

In one aspect of the present invention, a system for sharpening both a cutting knife and a hole plate of a meat grinder having an arbor for attaching said cutting knife and hole plate includes a universal arbor head provided at a distal end of the arbor, the universal arbor head having a peripherally disposed first shape portion and a centrally disposed second shape portion, wherein the first shape portion is adapted to rotate relative to the second shape portion; one or more first sharpening stones having a first shaped arbor hole dimensioned to operatively associate with the first shape portion; and one or more second sharpening stones having a second shaped arbor hole dimensioned to operatively associate with the second shape portion.

In another aspect of the present invention, a method of sharpening both a cutting knife and a hole plate of a meat grinder with only a set of sharpening stones, the meat grinder having an arbor for operatively attaching said cutting knife and said hole plate includes the steps of providing the immediately abovementioned system and replacing the plate hole with one second sharpening stone by operatively associating the respective second shape arbor hole with the second shaped portion so that the cutting knife rotates relative to the adjacent one second sharpening stone so as to at least resurface said cutting knife; replacing the one second sharpening stone replacing with hole plate; and separately replacing the cutting knife with one first sharpening stone by operatively associating the respective first shape arbor hole with the first shaped portion so that the one first sharpening stone rotates relative to the adjacent hole plate so as to at least resurface said hole plate.

In certain embodiments of the method, the universal arbor head is initially removably attached to the distal end of the arbor.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of knife sharpening stones of the present invention;

FIG. 2 is a front view of an exemplary embodiment of the knife sharpening stone of the present invention;

FIG. 3 is a perspective view of an exemplary embodiment of plate sharpening stones of the present invention;

FIG. 4 is a front view of an exemplary embodiment of the plate sharpening stone of the present invention;

FIG. 5 is an exploded view of an exemplary embodiment of the present invention, demonstrating a knife sharpening stone being placed in grinder;

FIG. 6 is a detail side view of an exemplary embodiment of the present invention, demonstrating a plate sharpening stone being placed in grinder;

FIG. 7 is a flow chart of an exemplary embodiment of the present invention; and

FIG. 8 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a sharpening system for a meat grinder. The sharpening system embodies two types of sharpening stones for sharpening the cutting edges of the knife blade and the hole plate, respectively, of the meat grinder, wherein each type of sharpening stone operatively associates to the drive arbor of the meat grinder. By interchangeably replacing the knife blade along the drive arbor with one type of sharpening stone so as to sharpen and resurface the hole plate, or replacing the hole plate along the drive with the other type of sharpening stone to sharpen and resurface the knife blade, the present invention provides hands-free sharpening with no additional machines or tools.

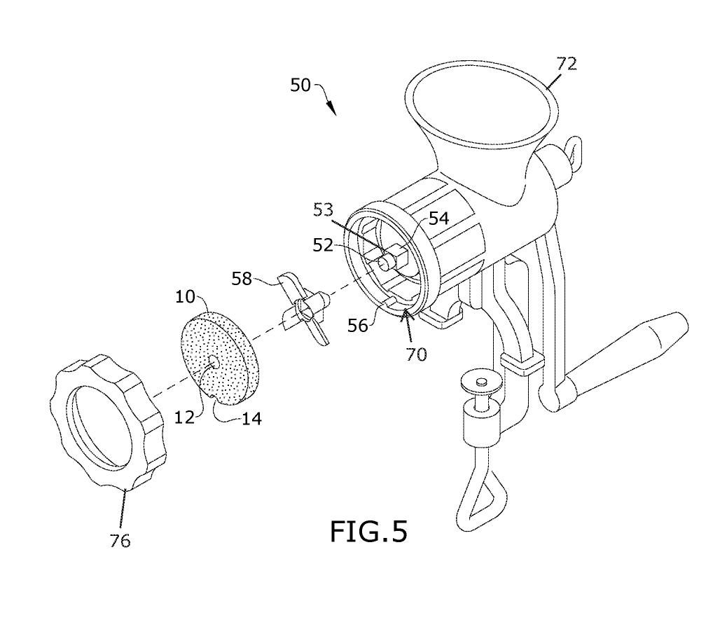

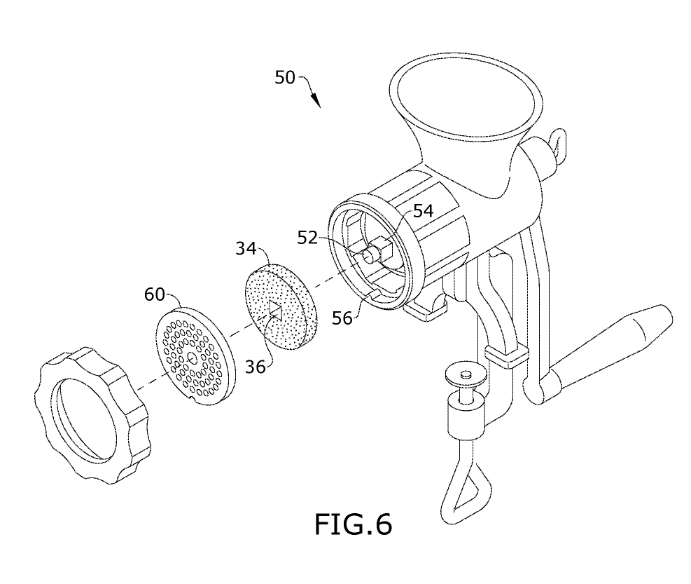

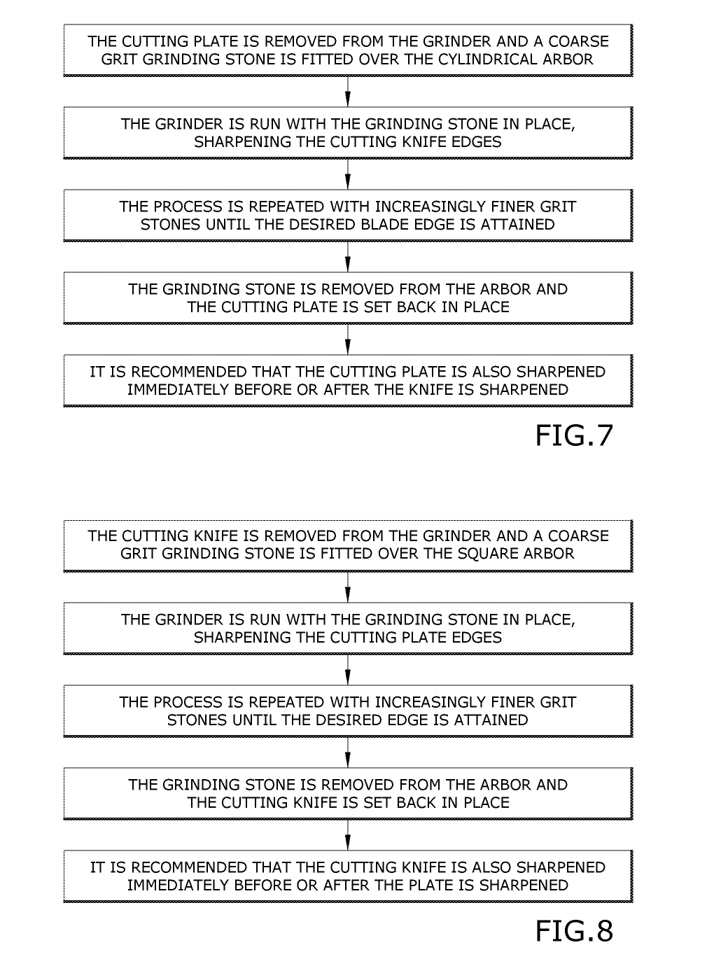

Referring to FIGS. 5 and 6, the present invention may include an interchangeable edge sharpening system for attaching sets of sharpening stones to a universal grinder drive unit for sharpening the cutting edges of a meat grinder 50 itself thereby not requiring additional machines or tools. The meat grinder 50 is a kitchen appliance for fine chopping and/or mincing of raw or cooked meat or other food stuff. Typical operation proceeds as follows: a user puts the foodstuff through a conveyor passage 70, usually by way of a funnel 72. At the end of the conveyor passage 70 there is a grinder knife 58 installed directly in front of a hole plate 60 through which the minced meat comes out of the machine. Running through the center of the conveyor passage 70 is a rotatable arbor terminating in an arbor head 53 onto which the grinder knife 58 and the hole plate 60, respectively, can operatively associate via appropriately shaped arbor holes for the grinder knife 58 and the hole plate 60. In certain embodiments, the arbor head may be “universal unit” 53, providing two different portions, a first shaped portion 54 rotatable relative to the second shaped portion 52. For example, the first shaped portion may be a peripheral square arbor head 54 rotatable relative to a fixed central circular arbor head 52 onto which the grinder knife 58 and the hole plate 60 are operatively associated, respectively. The first or second shape portions 54 and 52 can be substantially cylindrical, oval, square, triangular or other geometric shape so long as the universal arbor head 53 functions in accordance with the present invention as described herein. In certain embodiments, a separate universal arbor head 53 may be added to a non-universal end of the arbor.

Usually, the grinder knife 58 and hole plate 60 (since differently sized holes of the hole plates enables different byproducts of the foodstuff) are removably and securable with, in certain embodiments, a lockable cap 76. Also preexisting grinders 50 are adapted to be disassembled completely for cleaning. The

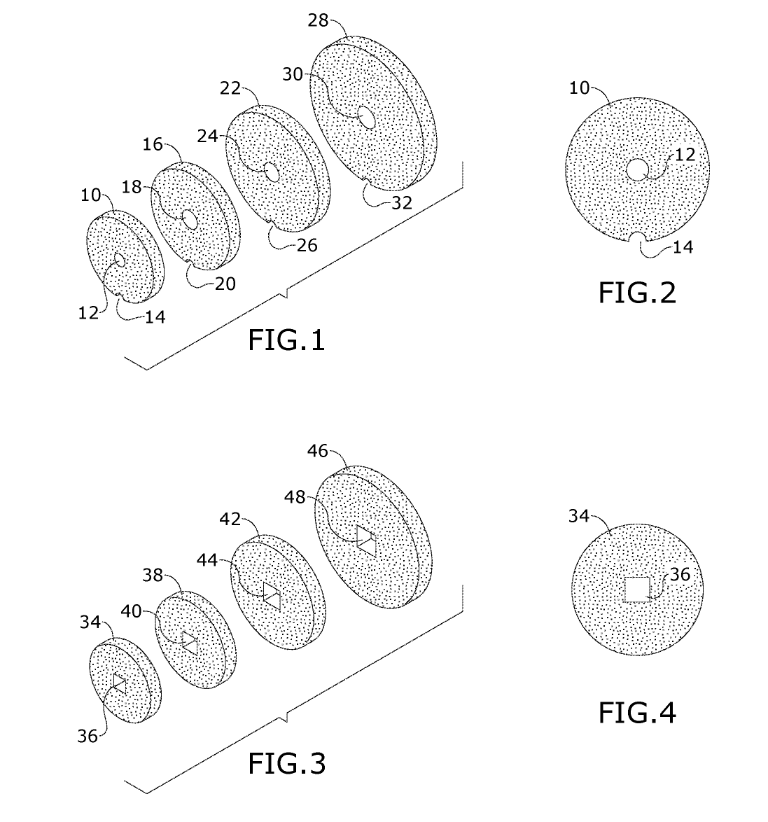

Referring to FIGS. 1 through 4, the interchangeable edge sharpening system of the present invention includes a set of various grinder knife sharpening stones 10, 16, 22, and 28, each such stone having circular arbor holes 12, 18, 24, and 30 and lock notches 14, 20, 26, and 32, respectively. The interchangeable edge sharpening system of the present invention also includes a set of various hole plate sharpening stones 34, 38, 42, and 46, each such stone having square arbor holes 36, 40, 44, and 48, respectively.

A method of using the present invention may include the following. The interchangeable edge sharpening system disclosed above may be provided. A user desiring to sharpen and resurface the hole plate 60 of the meat grinder 50 would first removed the grinder knife 58 and replace it will one of the plurality or set of various hole plate sharpening stones 34, 38, 42, and 46 so that their respective square arbor hole 36, 40, 44, or 48 operatively associates with the peripheral square arbor head 54, whereby the respective sharpening stone 34, 38, 42, or 46 may rotate about the arbor when powered, thereby sharpening and resurfacing the adjacent hole plate 60, as illustrated in FIG. 6.

A user desiring to sharpen and resurface the grinder knife 58 of the meat grinder 50 would first removed the hole plate 60 and replace it with one of the plurality or set of various grinder knife sharpening stones 10, 16, 22, and 28 so that their respective circular arbor holes 12, 18, 24, or 30 operatively associates with the inner circular arbor head 52 so that the respective grinder knife sharpening stones 10, 16, 22, or 28 may be fixed through operatively engaging their respective lock notches 14, 20, 26, or 32 and a locking element 56 so that the grinder knife 58 rotates relative to the grinder knife sharpening stone 10, 16, 22, or 28, thereby sharpening and resurfacing the adjacent grinder knife 58, as illustrated in FIG. 5.

Fresh, virgin edges on both pieces, the grinder knife 58 and the hole plate 60, allow for the very best cutting to be done as the pieces mate perfectly against each other. This creates a scissor type cutting effect.

The stones 10, 16, 22, 28, 34, 38, 42, and 46 may be ceramic abrasive wheels of differing grits and particularity. Each set of such stones may include at least one with a coarse grit abrasive stone to remove damaged material and chips from either cutting edge, and a fine stone to fine-tune either cutting edge after using the coarse one. The stones may be wetted with water for best results.

It should be understood, of course, that the foregoing relates to exemplary embodiments of the invention and that modifications may be made without departing from the spirit and scope of the invention as set forth in the following claims.

What is claimed is:

1. A system for sharpening both a cutting knife and a hole plate of a meat grinder having an arbor for attaching said cutting knife and hole plate, comprising:
a universal arbor head provided at a distal end of the arbor, the universal arbor head having a peripherally disposed first shape portion and a centrally disposed second shape portion, wherein the first shape portion is adapted to rotate relative to the second shape portion;
one or more first sharpening stones having a first shaped arbor hole dimensioned to operatively associate with the first shape portion; and
one or more second sharpening stones having a second shaped arbor hole dimensioned to operatively associate with the second shape portion.

2. The system of claim 1, wherein the first shape is square and the second shape is circular.

3. The system of claim 1, wherein the one or more first sharpening stones includes a coarse grit abrasive stone and a fine stone.

4. The system of claim 1, wherein the one or more second sharpening stones includes a coarse grit abrasive stone and a fine stone.

5. The system of claim 1, wherein the universal arbor head is removably attached to the distal end of the arbor.

6. The system of claim 1, wherein each second sharpening stone provides a lock notch for securely locking said second sharpening stone to the meat grinder.

7. A method of sharpening a hole plate of a meat grinder with only a set of sharpening stones, the meat grinder having an arbor for operatively attaching a cutting knife and hole plate, comprising the steps of:
providing the system of claim 1; and
replacing the cutting knife with one first sharpening stone by operatively associating the respective first shape arbor hole with the first shaped portion so that the one first sharpening stone rotates relative to the adjacent hole plate so as to at least resurface said hole plate.

8. A method of sharpening a cutting knife of a meat grinder with only a set of sharpening stones, the meat grinder having an arbor for operatively attaching said cutting knife and a hole plate, comprising the steps of:
providing the system of claim 1; and
replacing the plate hole with one second sharpening stone by operatively associating the respective second shape arbor hole with the second shaped portion so that the cutting knife rotates relative to the adjacent one second sharpening stone so as to at least resurface said cutting knife.

9. A method of sharpening both a cutting knife and a hole plate of a meat grinder with only a set of sharpening stones, the meat grinder having an arbor for operatively attaching said cutting knife and said hole plate, comprising the steps of:
providing the system of claim 1;
replacing the plate hole with one second sharpening stone by operatively associating the respective second shape arbor hole with the second shaped portion so that the cutting knife rotates relative to the adjacent one second sharpening stone so as to at least resurface said cutting knife;
replacing the one second sharpening stone replacing with hole plate; and
separately replacing the cutting knife with one first sharpening stone by operatively associating the respective first shape arbor hole with the first shaped portion so that the one first sharpening stone rotates relative to the adjacent hole plate so as to at least resurface said hole plate.

10. The method of claim 9, wherein the universal arbor head is initially removably attached to the distal end of the arbor.
